(19) United States
(12) Patent Application Publication
(10) Pub. No.: US 2007/0289687 A1
(43) Pub. Date: Dec. 20, 2007

(54) Display device

(76) Inventor: Stacey D. Floyd, Ogden, UT (US)

Correspondence Address: THORPE NORTH & WESTERN, LLP., 8180 SOUTH 700 EAST, SUITE 350, SANDY, UT, 84070, US

(21) Appl. No.: 11/445,866

(22) Filed: Jun. 2, 2006

(51) Int. Cl. B31B 1/60

(52) U.S. Cl. 156/1

(57) ABSTRACT

A display device having an elongate member with an adhesive, in one or more locations on the elongate member, with the adhesive having properties such that a face of the elongate member and a substantially planar surface, i.e., a face of another elongate member, a face of a sign, or a face of a supporting member cannot, after having been attached to one another, be separated and then reattached using the original adhesive. The adhesive is either remoistenable or protected by a release backing, the removal of which exposes the adhesive. Such release backing is preferably designed to be easily removable with a fingertip.

### BACKGROUND OF THE INVENTION

1. Field of the Invention

This invention relates to a display device comprising one or more elongate members, especially wooden sticks and even more especially craft sticks, coated with a pressure-sensitive adhesive for use preferably in educational and entertainment projects or as supports for signs.

2. Description of the Related Art

Wooden craft sticks have been used for years to produce all sorts of signs, visual aids and stick puppets. Teachers know that students each learn in different ways, so visual aids are very effective in showing, rather than telling, new ideas or concepts. Teachers often have the children themselves hold up the pictures in order to create a feeling of inclusion and self-confidence. The craft sticks make holding up the visuals easy for small hands as well as for older stumbling hands, but preparing these lessons is challenging. The difficulty comes when the sticks are glued to the pictures or other visuals needed for the lesson. A teacher has to plan far in advance when making these visual aids so that the glue will dry between the picture and the stick. Otherwise, when the stick is lifted up, the picture or other object will slop off the stick and onto the floor. If the picture is made of regular paper, the glue sometimes makes a soggy wrinkled mess of the picture where they make contact. It takes a lot of time to prepare nice-looking hand-held visual aids for lessons.

Another thing that craft sticks have been used for in the past is the building of log cabins, birdhouses, picture frames or other fabulous creations. Most children love to work with their hands to create these masterpieces. Often, due to the mess of liquid glue, a teacher, parent, or scout troop leader cannot afford the time required for the project and the cleanup. Even if they can take the time for the project, the journey home from school, or even just from the desk to the counter, can be devastating to the lovely construction and devastating to the builder, as well, when either the brittle dry glue cracks or shatters or soggy uncured glue slides and slops. Too many hand made gifts and projects never make it home from school.

The liquid glue and standard tapes found at stores are not easy to use when preparing visual aids or when building a model of any kind.

U.S. Pat. Nos. 4,259,790 and 4,273,537 disclose, in lines 48 through 52 of column 1 of U.S. Pat. No. 4,259,790 and lines 54 through 58 of column 1 in U.S. Pat. No. 4,273,537, “sticks, rods, tubes and other similar members which are sufficiently rigid to be self-supporting” with a “pressure sensitive adhesive material . . . applied to at least a portion of each rigid member.” And, according to lines 52 through 55 of column 1 in U.S. Pat. No. 4,259,790 and lines 58 through 61 of column 1 in U.S. Pat. No. 4,273,537, “It is preferred to apply the pressure sensitive adhesive material in the form of a knob or body of the material, mounted on at least one end, and preferably on both ends of the rigid member.” The adhesive which is utilized in those patents is, however, one that does not create stability by precluding disassembly and reattachment of the components; in fact, one object of those patents is, indeed, as stated in lines 18 through 20 of column 1 within both U.S. Pat. No. 4,259,790 and U.S. Pat. No. 4,273,537, to create an object with the sticks, etc. “which can readily be disassembled and reused repeatedly, over a long useful life.” This is further emphasized in lines 36 through 41 of column 8 in U.S. Pat. No. 4,259,790 and lines 9 through 14 of column 9 in U.S. Pat. No. 4,273,537, which provide, “If desired, the sticks can be cut to any desired length by the use of a pair of scissors. The knobs 22 of the pressure sensitive adhesive can be relocated to the cut ends of the sticks. If desired, the adhesive knobs can be subdivided and mounted on intermediate points on the sticks.”

And U.S. Pat. No. 5,251,943 illustrates a craft stick as one embodiment of an elongate member having an end coated with an adhesive in order to pick up beads and other items to be used in needlework and other handicraft projects. Again, however, according to lines 62 through 63 in column 2, “If an adhesive is to be used on the pick-up device . . . , the adhesive should . . . allow[s] the easy removal of things stuck to the adhesive.”

### BRIEF SUMMARY OF THE INVENTION

The Display Device of the present invention comprises an elongate member, preferably a wooden stick, and even more preferably a craft stick, with an adhesive, in one or more locations on the elongate member, having properties such that a face of the elongate member and a substantially planar surface, i.e., a face of another elongate member, a face of a sign, or a face of a supporting member cannot, after having been attached to one another, be separated and then reattached using the original adhesive. The elongate member can, however, be constructed from any material, such as plastic or metal, which is sufficiently rigid to be self supporting. And, as suggested above, the adhesive enables the elongate members to adhere to one another, to another supporting member, or to an object to be supported. (As used herein, the term “sign” shall be understood to include a tangible object containing textual information, a tangible object containing numerical information, a tangible object containing graphical information, a tangible object containing a figure that one of ordinary skill in the art would consider entertaining, or a tangible object containing educational information.)

The adhesive is either remoistenable or protected by a release backing, the removal of which exposes the adhesive. Such release backing is preferably designed to be easily removable with a fingertip.

With the adhesive, the elongate member is able firmly to hold a variety of objects and materials having a substantially planar surface. The adhesive, furthermore, preferably works on cardboard, paper, construction paper, laminated paper, foam rubber, felt, cork, wood, and many other substrates.

When connected together or to another supporting member, the elongate members can be used in modeling projects to enable children and adults alike the opportunity to build durable structures, such as buildings, ships, napkin holders, picture frames, and the like without enduring the challenge of liquid glue.

When attached to another material, the elongate member serves as a supporting handle for stick puppets, textual or graphical displays, and other visual aids.

The properties discussed above for the adhesive provide the requisite durable strength for holding objects or creating structures; repositionable or reusable adhesives lack this quality.

### BRIEF DESCRIPTION OF THE SEVERAL VIEWS OF THE DRAWING

FIG. 1 shows exemplary locations where adhesive is placed on elongate members.

FIG. 2 is a perspective view of a variety of exemplary shapes for the elongate member.

FIG. 3 is a lateral cross-sectional view of a pressure-sensitive adhesive having a carrier.

FIG. 4 is a lateral cross-sectional view of a pressure-sensitive adhesive having no carrier.

FIG. 5 is a lateral cross-sectional view of a remoistenable adhesive.

FIG. 6 illustrates the use of the elongate member as a supporting handle for an object, specifically, a hand puppet.

FIG. 7 illustrates the use of the elongate member as supporting handles for objects, specifically, a poster containing a mathematical problem and another poster containing the answer to the problem.

FIG. 8 illustrates the use of the elongate member as a handle for an object, specifically, a “for sale” sign.

FIG. 9 portrays a simple geometric structure, which could be used as a picture frame, created with several elongate members.

FIG. 10 shows a cabin built by attaching elongate members to a supporting member.

### DETAILED DESCRIPTION OF THE INVENTION

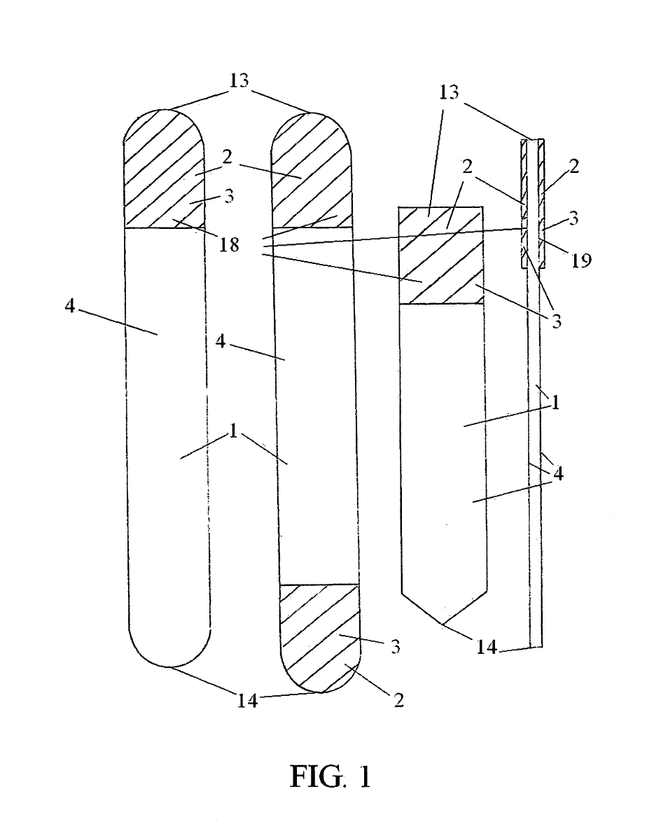

As indicated above, the Display Device comprises, as illustrated in FIG. 1, an elongate member 1 with an adhesive 2 in one or more locations 3 on the elongate member 1. The adhesive 2 is, as also discussed above, selected to have properties such that a face 4 of the elongate member 1 and a substantially planar surface 5, i.e., a face 4 of another elongate member 1, a face 6 of a sign 7, or a face 8 of a supporting member 9 cannot, after having been attached to one another with the adhesive 2, be separated and then reattached using the original adhesive 2.

The elongate member 1 may, as also noted above, be constructed from any material, such as plastic or metal, which is sufficiently rigid to cause the elongate member 1 to be self supporting, although wood is preferred.

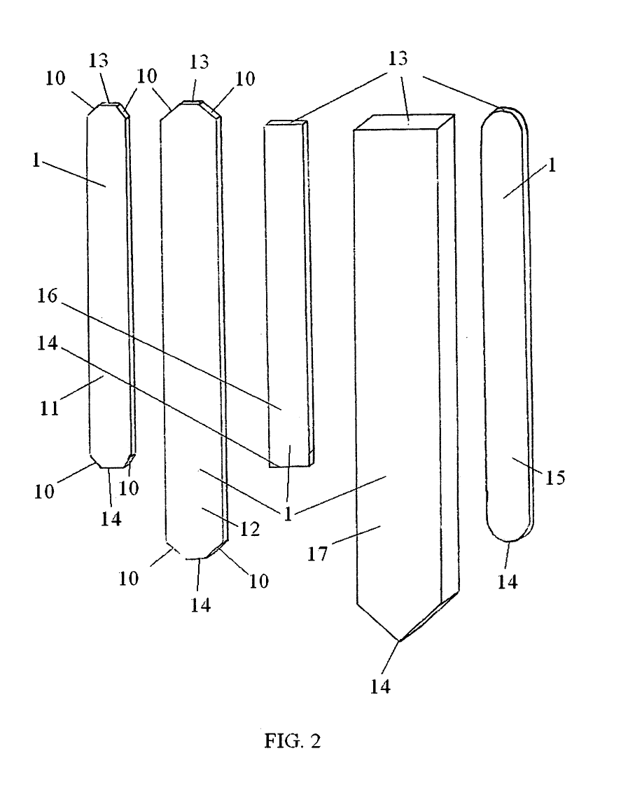

For safety, preferably either the corners 10 of the elongate member 1 are rounded or truncated, as shown in the first two exemplary shapes 11, 12 of FIG. 2, or the first end 13 and the second end 14 of the elongate member 1 are rounded, as illustrated by the fifth exemplary shape 15 of FIG. 2. For an elongate member 1 that is intended to be utilized to construct a structure, the corners 10 are, however, preferably squared, as pictured in the third exemplary shapes 16 of FIG. 2. Of course, if desired, any number of corners 10 less than all could be rounded; also, only one end 13, 14 could be rounded. And the fourth exemplary shape 17 of FIG. 2 has a first end 13 that is shaped to facilitate insertion into the ground, e.g., pointed.

The dimensions of the elongate member 1 are not critical. There are, though, preferred dimensions. For the first exemplary shape 11, the second exemplary shape 12, the third exemplary shape 16, and the fifth exemplary shape 15 of FIG. 2, the thickness is preferably substantially one-eighth inch, the width preferably varies from three-eighth inch to one inch, and the length preferably varies from three inches to eight inches. The fourth exemplary shape 17 is preferably two inches wide, one-half inch thick, and at least eight inches long.

The adhesive 2 can be placed in any desired location 3 but is, as illustrated in FIG. 1, preferably placed on one or both opposing lateral faces 18, 19 near one or more of the ends 13, 14 of the elongate member 1.

It is, as indicated above, important that the adhesive 2 have sufficient initial tack, fiber tear, and bond strength that a face 4 of an elongate member 1 and a substantially planar surface 5, i.e., a face 4 of another elongate member 1, a face 6 of a sign 7, or a face 8 of a supporting member 9 cannot, after having been attached to one another with the adhesive 2, be separated and then reattached using the original adhesive 2.

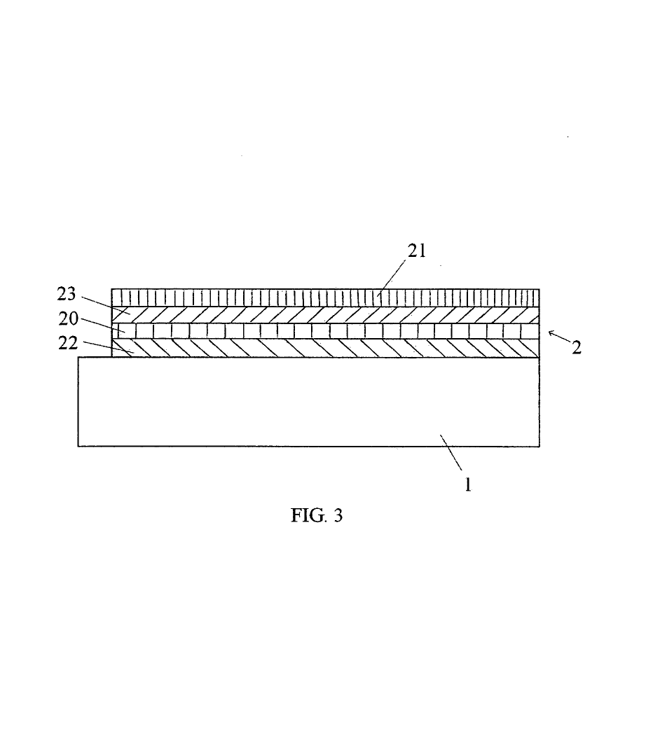

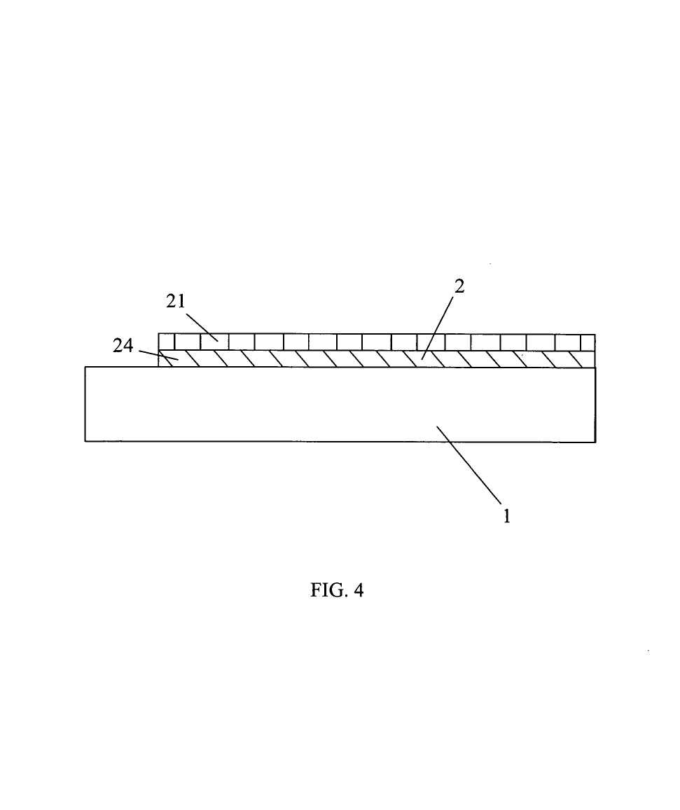

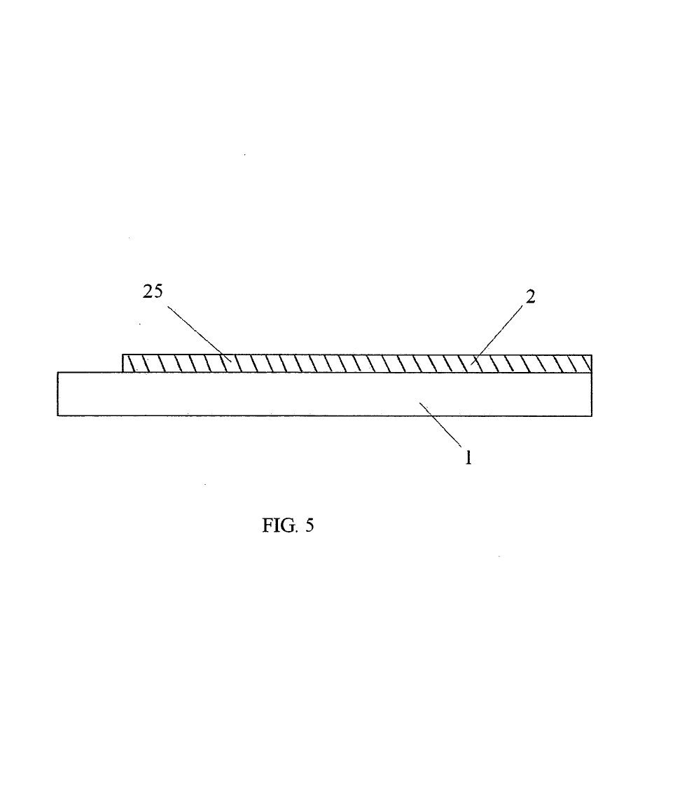

As long as the adhesive 2 possesses the preceding properties, it can be any type of adhesive 2. For example, it may be a pressure-sensitive adhesive (often termed a “permanent” pressure-sensitive adhesive when it has the identified properties) with a carrier 20, as shown in FIG. 3; a pressure-sensitive without a carrier 20 (also termed an “unsupported” pressure-sensitive adhesive), as portrayed in FIG. 4; a remoistenable adhesive (either a starch-based remoistenable adhesive or a remoistenable hotmelt adhesive), as illustrated in FIG. 5; or a pressure-sensitive hotmelt adhesive.

Any technique that is well known in the art may be utilized to apply the adhesive 2 to the elongate member 1. For example, a pressure-sensitive adhesive having a carrier 20 can be cut or formed to fit the elongate member 1 and then pressed onto the elongate member 1; and a pressure-sensitive adhesive without a carrier 20 and a remoistenable adhesive can be rolled or sprayed onto the elongate member 1.

Film adhesives may also be utilized. They are dried rolls of adhesives and are also generally hotmelt adhesives which become pressure sensitive after application.

Similarly, powder adhesives that become pressure sensitive after application are also acceptable.

Two preferred specific products are the CRAIGBOND 3256 C liquid pressure-sensitive adhesive from Craig Adhesives and Coatings Company in Newark, N.J., and the Adchem 5008 double-coated polyester film manufactured by the Adchem Corporation of Riverhead, N.Y.

As shown in FIG. 3 and FIG. 4 the pressure-sensitive adhesives are covered with a release liner 21 to prevent the adhesive 2 from unintentionally contacting an object whereas, as illustrated in FIG. 5, a remoistenable adhesive does not require a release liner 21.

FIG. 3 shows a lateral cross section of a pressure sensitive adhesive having a carrier 20 placed on an elongate member 1. Adjacent to the elongate member 1 is a first adhesive layer 22, adjacent to the first adhesive layer 22 in a direction opposite to that of the elongate member 1 is the carrier 20, adjacent to the carrier 20 in a direction opposite to that of the elongate member 1 is a second adhesive layer 23, and adjacent to the second adhesive layer 23 in a direction opposite to that of the elongate member 1 is a release liner 21.

FIG. 4 depicts a lateral cross section of a pressure sensitive adhesive having no carrier, 20 placed on an elongate member 1. Adjacent to the elongate member 1 is an adhesive layer 24. And adjacent to the adhesive layer 24 in a direction opposite to that of the elongate member 1 is a release liner 21.

FIG. 5 illustrates a lateral cross section of a remoistenable adhesive placed on an elongate member 1. This comprises only a layer 25 of adhesive 2.

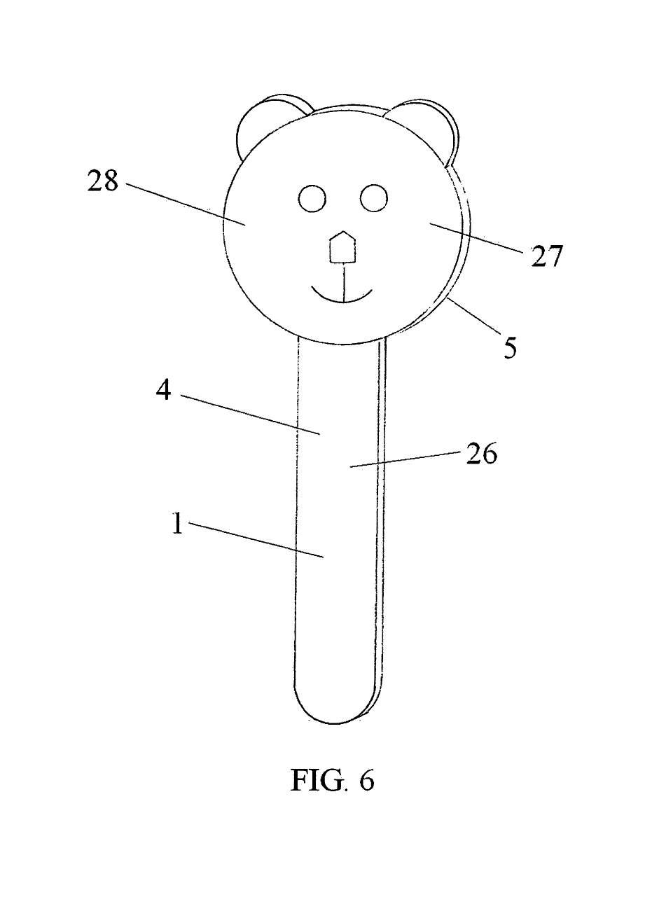

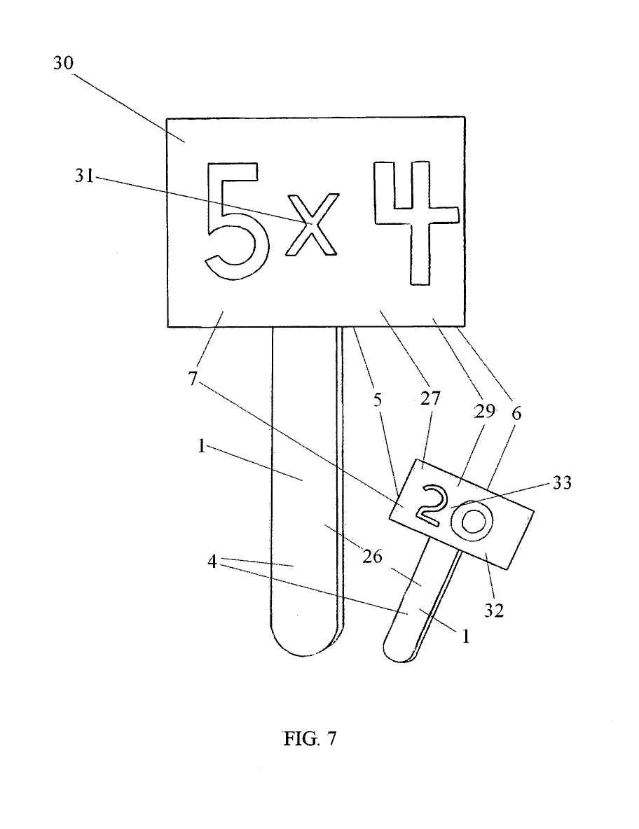

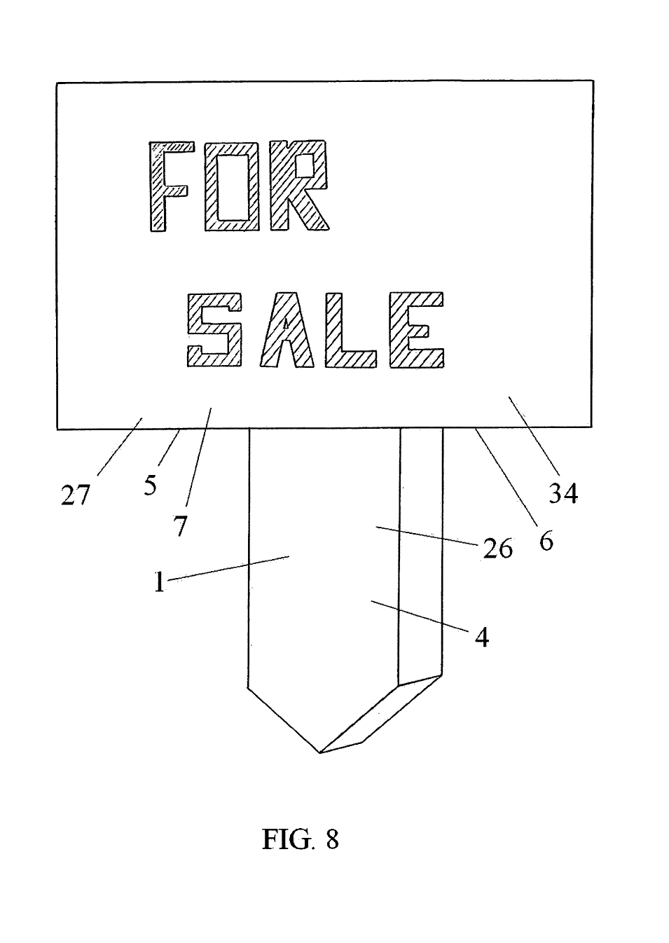

There are, as has been indicated above, a number of uses of the Adhering Elongate Member. Illustrative or exemplary such uses include having an elongate member 1 serve as a supporting handle 26 for an object 27. In FIG. 6 the object is a hand puppet 28; in FIG. 7, two posters 29, with one poster 30 displaying a mathematical problem 31 and with the other poster 32 showing the answer 33 to the mathematical problem 31; and in FIG. 8, a “for sale” sign 34.

Further illustrative or exemplary uses include creating structures 35.

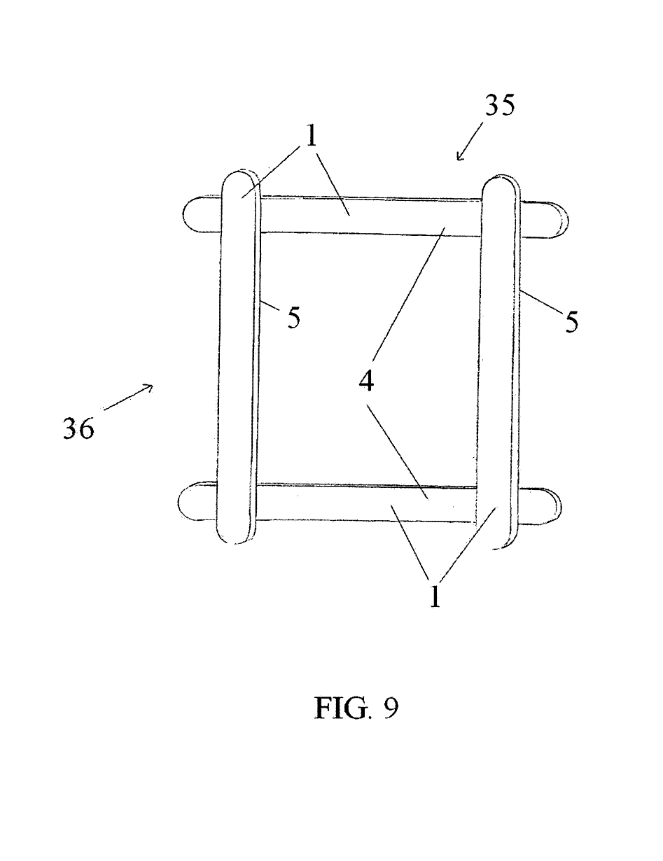

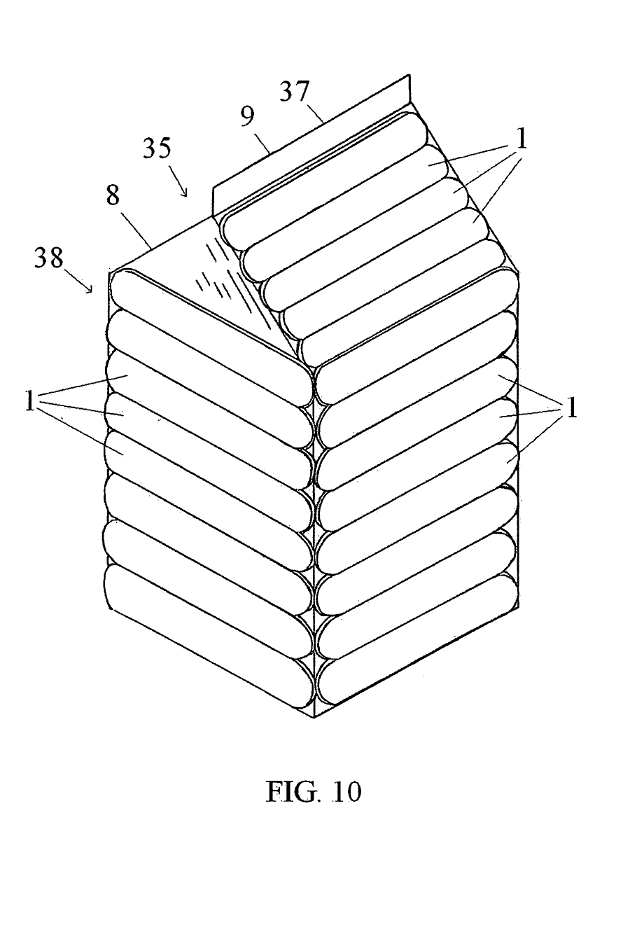

In FIG. 9 elongate members 1 have been connected together in order to make a simple geometric object 36, which could be used as a picture frame. And in FIG. 10 elongate members 1 have been attached to faces 8 of a supporting member 9, preferably, a milk carton 37 to build a cabin 38.

As used herein, the term “substantially” indicates that one skilled in the art would consider the value modified by such terms to be within acceptable limits for the stated value. Also as used herein, the term “preferable” or “preferably” means that a specified element or technique is more acceptable than another but not that such specified element or technique is a necessity.

I claim:

1. A display device, which comprises:
an elongate member, said elongate member having opposing lateral faces, said elongate member having a first end, said elongate member having a second end, and said elongate member being sufficiently rigid to be self supporting; and
an adhesive, said adhesive being located on at least one of the opposing lateral faces of said elongate member for attaching said elongate member to a substantially planar surface and said adhesive selected to have properties such that said elongate member, after having been attached to the substantially planar surface with said adhesive, cannot be separated from and then reattached to the substantially planar surface using said adhesive.

2. The display device as recited in claim 1, wherein:
said adhesive is a remoistenable adhesive.

3. The display device as recited in claim 2, wherein:
said remoistenable adhesive is located on at least one of the opposing lateral faces of said elongate member near at least one of the ends of said elongate member.

4. The display device as recited in claim 1, further comprising:
a release liner adjacent to said adhesive in a direction opposite to that of said elongate member and wherein:
said adhesive is a pressure-sensitive adhesive.

5. The display device as recited in claim 4, wherein:
said pressure-sensitive adhesive is located on at least one of the opposing lateral faces of said elongate member near at least one of the ends of said elongate member.

6. The display device as recited in claim 1, wherein:
said adhesive is located on at least one of the opposing lateral faces of said elongate member near at least one of the ends of said elongate member.

7. A display device, which comprises:
an elongate member, said elongate member having opposing lateral faces, said elongate member having a first end, said elongate member having a second end, and said elongate member being sufficiently rigid to be self supporting;
a substantially planar surface; and
an adhesive, said adhesive being located on at least one of the opposing lateral faces of said elongate member, said adhesive attaching said elongate member to said substantially planar surface, and said adhesive selected to have properties such that said elongate member, after having been attached to said substantially planar surface with said adhesive, cannot be separated from and then reattached to said substantially planar surface using said adhesive.

8. The display device as recited in claim 7, wherein:
said substantially planar surface is an opposing lateral face of another elongate member.

9. The display device as recited in claim 7, wherein:
said substantially planar surface is a face of a sign.

10. The display device as recited in claim 7, wherein:
said substantially planar surface is a face of a supporting member.

11. The display device as recited in claim 7, wherein:
said adhesive is a remoistenable adhesive.

12. The display device as recited in claim 11, wherein:
said substantially planar surface is an opposing lateral face of another elongate member.

13. The display device as recited in claim 11, wherein:
said substantially planar surface is a face of a sign.

14. The display device as recited in claim 11, wherein:
said substantially planar surface is a face of a supporting member.

15. The display device as recited in claim 11, wherein:
said remoistenable adhesive is located on at least one of the opposing lateral faces of said elongate member near at least one of the ends of said elongate member.

16. The display device as recited in claim 15, wherein:
said substantially planar surface is an opposing lateral face of another elongate member.

17. The display device as recited in claim 15, wherein:
said substantially planar surface is a face of a sign.

18. The display device as recited in claim 15, wherein:
said substantially planar surface is a face of a supporting member.

19. The display device as recited in claim 7, further comprising:
a release liner adjacent to said adhesive in a direction opposite to that of said elongate member and wherein:
said adhesive is a pressure-sensitive adhesive.

20. The display device as recited in claim 19, wherein:
said substantially planar surface is an opposing lateral face of another elongate member.

21. The display device as recited in claim 19, wherein:
said substantially planar surface is a face of a sign.

22. The display device as recited in claim 19, wherein:
said substantially planar surface is a face of a supporting member.

23. The display device as recited in claim 19, wherein:
said pressure-sensitive adhesive is located on at least one of the opposing lateral faces of said elongate member near at least one of the ends of said elongate member.

24. The display device as recited in claim 23, wherein:
said substantially planar surface is an opposing lateral face of another elongate member.

25. The display device as recited in claim 23, wherein:
said substantially planar surface is a face of a sign.

26. The display device as recited in claim 23, wherein:
said substantially planar surface is a face of a supporting member.

27. The display device as recited in claim 7, wherein:
said adhesive is located on at least one of the opposing lateral faces of said elongate member near at least one of the ends of said elongate member.

28. The display device as recited in claim 27, wherein:
said substantially planar surface is an opposing lateral face of another elongate member.

29. The display device as recited in claim 27, wherein:
said substantially planar surface is a face of a sign.

30. The display device as recited in claim 27, wherein:
said substantially planar surface is a face of a supporting member.
